(19) United States
(12) Patent Application Publication
(10) Pub. No.: US 2026/0081912 A1
(43) Pub. Date: Mar. 19, 2026

(54) COMPUTER SECURITY BASED ON CLIENT-SIDE CHECKING OF SECURE COMPUTER NETWORK COMMUNICATIONS

(71) Applicant: ISLAND TECHNOLOGY INC., DALLAS, TX (US)

(72) Inventor: DOR ROTMAN, RISHON LEZION (IL)

(21) Appl. No.: 19/332,103

(22) Filed: Sep. 18, 2025

Related U.S. Application Data
(60) Provisional application No. 63/696,389, filed on Sep. 19, 2024.

(51) Int. Cl. H04L 9/40

(52) U.S. Cl. CPC H04L 63/0823; H04L 63/10

(57) ABSTRACT

A computer security method including sending a communication from a first computer to a second computer via a computer network, where the sending is performed in accordance with a predefined policy indicating an identity of the second computer in association with a predefined computer security privilege, receiving at the first computer a certificate sent from the second computer via the computer network in response to the communication, where the certificate is signed with a private key of a certificate authority, determining, responsive to receipt of the certificate at the first computer, and using a public key of the certificate authority, whether the certificate is valid, and granting the predefined computer security privilege at the first computer responsive to determining that the certificate is valid.

### FIELD

The invention relates generally to computer security.

### BACKGROUND

Organizations often employ different computer security measures regarding their employees' computing devices based on whether they are currently connected to an organization's computer network. For example, access to an organization's computer servers may be limited to computing devices that are currently connected to the organization's computer network. Unfortunately, known techniques for checking whether a computing device is currently connected to an organization's computer network are often vulnerable to attacks by malicious actors or require specialized knowledge, equipment, or maintenance.

### SUMMARY

In one aspect of the invention a computer security method is provided including sending a communication from a first computer to a second computer via a computer network, where the sending is performed in accordance with a predefined policy indicating an identity of the second computer in association with a predefined computer security privilege, receiving at the first computer a certificate sent from the second computer via the computer network in response to the communication, where the certificate is signed with a private key of a certificate authority, determining, responsive to receipt of the certificate at the first computer, and using a public key of the certificate authority, whether the certificate is valid, and granting the predefined computer security privilege at the first computer responsive to determining that the certificate is valid.

In another aspect of the invention the determining is performed in accordance with the predefined policy, where the predefined policy indicates the certificate authority that is to be used to determine whether the certificate is valid.

In another aspect of the invention the second computer is accessible to the first computer only within the computer network.

In another aspect of the invention the sending is periodically performed in accordance with a predefined schedule included in the predefined policy.

In another aspect of the invention the method further includes revoking the predefined computer security privilege at the first computer responsive to determining that the certificate is invalid.

In another aspect of the invention the method further includes configuring a computer software application to perform the sending, receiving, determining, and granting.

In another aspect of the invention the computer software application is hosted by the first computer.

In another aspect of the invention the computer software application is any of a desktop application, a web browser, a web browser plugin, a web-browser add-in, and a web browser extension. and a kernel driver.

In another aspect of the invention a computer security system is provided including a communications manager configured to send a communication from a first computer to a second computer via a computer network in accordance with a predefined policy indicating an identity of the second computer in association with a predefined computer security privilege, and receive at the first computer a certificate sent from the second computer via the computer network in response to the communication, where the certificate is signed with a private key of a certificate authority, and a security manager configured to determine, responsive to receipt of the certificate at the first computer, and using a public key of the certificate authority, whether the certificate is valid, and grant the predefined computer security privilege at the first computer responsive to determining that the certificate is valid.

In another aspect of the invention the predefined policy indicates the certificate authority that is to be used to determine whether the certificate is valid.

In another aspect of the invention the predefined policy includes a predefined schedule for periodically sending the communication.

In another aspect of the invention the security manager is configured to revoke the predefined computer security privilege at the first computer responsive to determining that the certificate is invalid.

In another aspect of the invention the computer security system further includes configuring any of the communications manager and the security manager as a computer software application.

### BRIEF DESCRIPTION OF THE DRAWINGS

Aspects of the invention will be understood and appreciated more fully from the following detailed description taken in conjunction with the appended drawings in which:

FIG. 1 is a simplified conceptual illustration of a computer security system, constructed and operative in accordance with an embodiment of the invention; and

FIG. 2 is a simplified flowchart illustration of an exemplary method of operation of the system of FIG. 1, operative in accordance with an embodiment of the invention.

### DETAILED DESCRIPTION

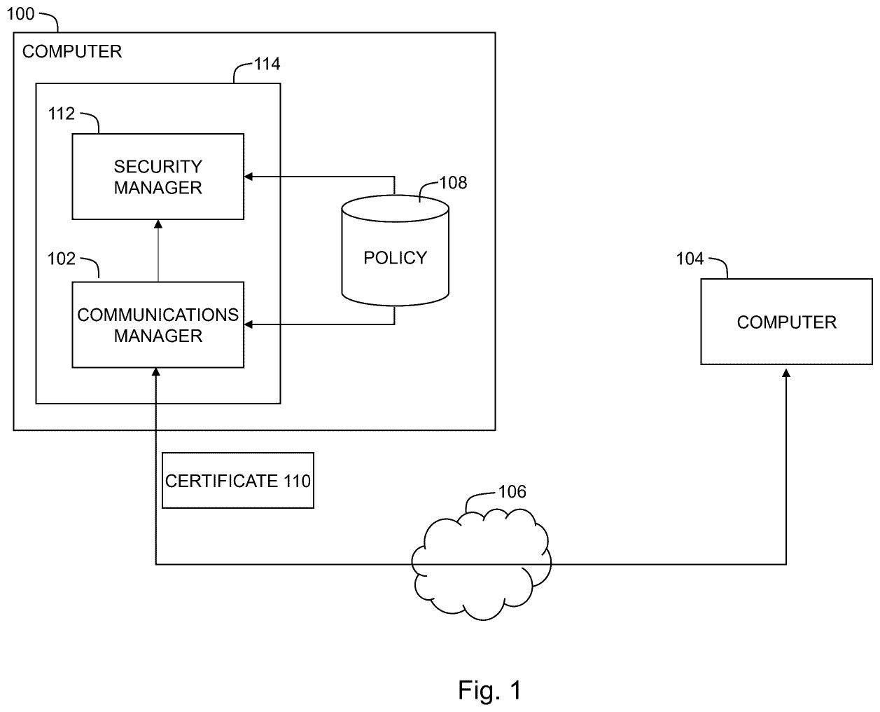

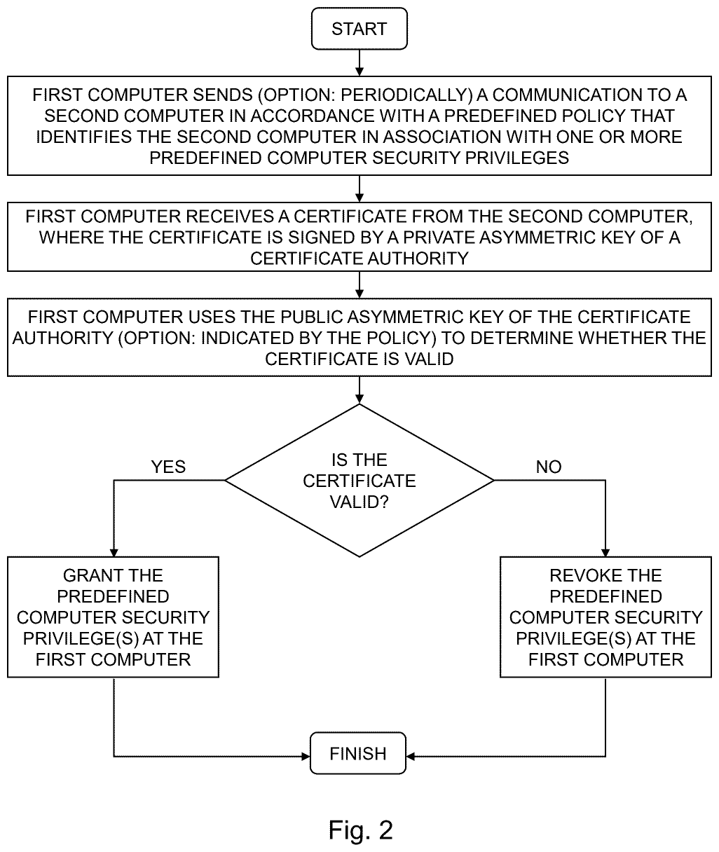

Reference is now made to FIG. 1, which is a simplified conceptual illustration of a computer security system, constructed and operative in accordance with an embodiment of the invention, and additionally to FIG. 2, which is a simplified flowchart illustration of an exemplary method of operation of the system of FIG. 1, operative in accordance with an embodiment of the invention. In the system of FIG. 1 and method of FIG. 2, a computer 100 is configured with a communications manager 102 that is configured to send a communication from computer 100 to a computer 104 via a computer network 106. Communications manager 102 is configured to send the communication in accordance with a predefined policy 108 with which computer 100 is configured, such as where policy 108 is provided to computer 100 by a system administrator. Communications manager 102 is configured to send the communication in accordance with a predefined protocol, such as the Hypertext Transfer Protocol Secure (HTTPS) protocol, where the communication is configured to cause computer 104 to provide, in response to the communication, a certificate 110 that computer 104 sends to computer 100 via computer network 106, where certificate 110 is signed with a private asymmetric key of a certificate authority in accordance with conventional techniques.

In accordance with the invention, policy 108 indicates an identity of computer 104, such as its computer network address or Uniform Resource Locator (URL), in association with one or more predefined computer security privileges. Examples of such computer security privileges include not performing virus checking, or allowing access to computer servers or other resources that are only accessible from within computer network 106, preferably where the computer security privileges are only granted when computer 100 is connected to computer network 106, such as where computer network 106 is a company network or other private network. Preferably, computer 104 is accessible to computer 100 only within computer network 106.

Computer 100 is also configured with a security manager 112 that is configured to determine, in accordance with conventional techniques, responsive to receipt of certificate 110 at computer 100, and using a public asymmetric key of the certificate authority, whether certificate 110 is valid. In one embodiment, policy 108 additionally identifies the certificate authority that is to be used by security manager 112 to determine whether certificate 110 is valid. Security manager 112 is further configured to grant the predefined computer security privilege at computer 100 responsive to determining that certificate 110 is valid.

In one embodiment, policy 108 includes a predefined schedule according to which communications manager 102 periodically sends the communication to computer 104 as described above. In one embodiment, security manager 112 is configured to revoke the predefined computer security privilege at computer 100 responsive to determining that certificate 110 is invalid.

Communications manager 102 and security manager 112 are preferably implemented in accordance with conventional techniques in computer hardware and/or in computer software embodied in a non-transitory, computer-readable medium. In one embodiment, communications manager 102 and security manager 112 are implemented in a computer software application 114, such as where computer software application 114 is a web browser such as is described in U.S. patent application Ser. No. 17/740,457 and Ser. No. 17/993,919, and where policy 108 is provided to computer 100 as described therein. In other embodiments, communications manager 102 and security manager 112 are implemented in accordance with conventional techniques as any of a desktop application, a web browser plugin, a web-browser add-in, a web browser extension, and a kernel driver.

The invention, in embodiments thereof, thus provides for granting a predefined computer security privilege at a first computer only after the first computer, in accordance with a predefined policy with which the first computer is configured, validates a certificate received from a second computer, where the predefined policy identifies, in association with the predefined computer security privilege, the second computer from which the first computer is to receive the certificate, and, in one embodiment, the certificate authority that is to be used to validate the certificate. Thus, for example, the policy may be configured such that the second computer is only accessible to the first computer within a private computer network, thereby ensuring, upon validation of the certificate, that the computer security privilege is only granted to the first computer when the first computer is operating within the confines of the private computer network. Furthermore, configuring the policy to specify the certificate authority that is to be used to validate the certificate, rather than allowing the first computer to select its own trusted certificate authority based on the received certificate, provides a defense against other attack vectors.

Any aspect of the invention described herein may be implemented in computer hardware and/or computer software embodied in a non-transitory, computer-readable medium in accordance with conventional techniques, the computer hardware including one or more computer processors, computer memories, I/O devices, and network interfaces that interoperate in accordance with conventional techniques.

It is to be appreciated that the term “processor” or “device” as used herein is intended to include any processing device, such as, for example, one that includes a CPU (central processing unit) and/or other processing circuitry. It is also to be understood that the term “processor” or “device” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart illustrations and block diagrams in the drawing figures illustrate the architecture, functionality, and operation of possible implementations of systems, methods, and computer program products according to various embodiments of the invention. In this regard, each block in the flowchart illustrations or block diagrams may represent a module, segment, or portion of computer instructions, which comprises one or more executable computer instructions for implementing the specified logical function(s). In some alternative implementations, the functions noted in a block may occur out of the order noted in the drawing figures. For example, two blocks shown in succession may, in fact, be executed substantially concurrently, or the blocks may sometimes be executed in the reverse order, depending upon the functionality involved. It will also be noted that each block of the flowchart illustrations and block diagrams, and combinations of such blocks, can be implemented by special-purpose hardware-based and/or software-based systems that perform the specified functions or acts.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments.

What is claimed is:

1. A computer security method comprising:
sending a communication from a first computer to a second computer via a computer network, wherein the sending is performed in accordance with a predefined policy indicating an identity of the second computer in association with a predefined computer security privilege;
receiving at the first computer a certificate sent from the second computer via the computer network in response to the communication, wherein the certificate is signed with a private key of a certificate authority;
determining, responsive to receipt of the certificate at the first computer, and using a public key of the certificate authority, whether the certificate is valid; and
granting the predefined computer security privilege at the first computer responsive to determining that the certificate is valid.

2. The computer security method according to claim 1, wherein the determining is performed in accordance with the predefined policy, wherein the predefined policy indicates the certificate authority that is to be used to determine whether the certificate is valid.

3. The computer security method according to claim 1, wherein the second computer is accessible to the first computer only within the computer network.

4. The computer security method according to claim 1, wherein the sending is periodically performed in accordance with a predefined schedule included in the predefined policy.

5. The computer security method according to claim 4 and further comprising revoking the predefined computer security privilege at the first computer responsive to determining that the certificate is invalid.

6. The computer security method according to claim 1 and further comprising configuring a computer software application to perform the sending, receiving, determining, and granting.

7. The computer security method according to claim 6, wherein the computer software application is hosted by the first computer.

8. The computer security method according to claim 6, wherein the computer software application is any of a desktop application, a web browser, a web browser plugin, a web-browser add-in, and a web browser extension. and a kernel driver.

9. A computer security system comprising:
a communications manager configured to
send a communication from a first computer to a second computer via a computer network in accordance with a predefined policy indicating an identity of the second computer in association with a predefined computer security privilege, and
receive at the first computer a certificate sent from the second computer via the computer network in response to the communication, wherein the certificate is signed with a private key of a certificate authority; and
a security manager configured to
determine, responsive to receipt of the certificate at the first computer, and using a public key of the certificate authority, whether the certificate is valid, and
grant the predefined computer security privilege at the first computer responsive to determining that the certificate is valid.

10. The computer security system according to claim 9, wherein the predefined policy indicates the certificate authority that is to be used to determine whether the certificate is valid.

11. The computer security system according to claim 9, wherein the second computer is accessible to the first computer only within the computer network.

12. The computer security system according to claim 9, wherein the predefined policy includes a predefined schedule for periodically sending the communication.

13. The computer security system according to claim 12, wherein the security manager is configured to revoke the predefined computer security privilege at the first computer responsive to determining that the certificate is invalid.

14. The computer security system according to claim 9 and further comprising configuring any of the communications manager and the security manager as a computer software application.

15. The computer security system according to claim 14, wherein the computer software application is hosted by the first computer.

16. The computer security system according to claim 14, wherein the computer software application is any of a desktop application, a web browser, a web browser plugin, a web-browser add-in, a web browser extension, and a kernel driver.
